(19) United States
(12) Patent Application Publication
(10) Pub. No.: US 2019/0224067 A1
(43) Pub. Date: Jul. 25, 2019

(54) SCIATICA THERAPY ASSEMBLY

(71) Applicant: Michelle Mock, Macon, GA (US)

(72) Inventor: Michelle Mock, Macon, GA (US)

(21) Appl. No.: 15/878,209

(22) Filed: Jan. 23, 2018

(51) Int. Cl. A61H 7/00

(52) U.S. Cl. CPC A61H 7/001; A61H 2205/086; A61H 2203/0425; A61H 2201/1628

(57) ABSTRACT

A sciatica therapy assembly for treating symptoms of sciatica includes a pad that may be positioned on a support surface thereby facilitating the pad to be sat upon. A pair of massagers is provided and each of the massagers is removably positioned in the pad. Thus, each of the massagers is sat upon when the pad is sat upon. The massagers are spaced apart from each other on the pad such that each of the massagers is aligned with each of the user's sciatic nerves. In this way the massagers facilitating the sciatic nerves to be massaged for reducing pain and discomfort associated with sciatica.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention.

### (2) Description of Related Art including Information Disclosed Under 37 CFR 1.97 and 1.98.

The disclosure and prior art relates to therapy devices and more particularly pertains to a new therapy device for relieving symptoms of sciatica.

### BRIEF SUMMARY OF THE INVENTION

An embodiment of the disclosure meets the needs presented above by generally comprising a pad that may be positioned on a support surface thereby facilitating the pad to be sat upon. A pair of massagers is provided and each of the massagers is removably positioned in the pad. Thus, each of the massagers is sat upon when the pad is sat upon. The massagers are spaced apart from each other on the pad such that each of the massagers is aligned with each of the user's sciatic nerves. In this way the massagers facilitating the sciatic nerves to be massaged for reducing pain and discomfort associated with sciatica.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a sciatica therapy assembly according to an embodiment of the disclosure.

FIG. 2 is a bottom view of an embodiment of the disclosure.

FIG. 3 is a cross sectional view taken along line 3-3 of FIG. 4 of an embodiment of the disclosure.

FIG. 4 is a top view of an embodiment of the disclosure.

FIG. 5 is an exploded perspective view of an embodiment of the disclosure.

FIG. 6 is a top view of an alternative embodiment of the disclosure.

FIG. 7 is a perspective view of an alternative embodiment of the disclosure.

### DETAILED DESCRIPTION OF THE INVENTION

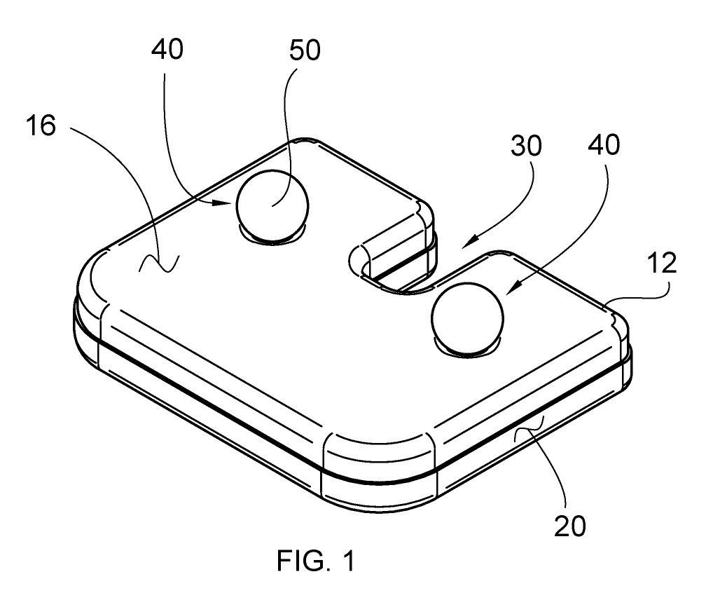

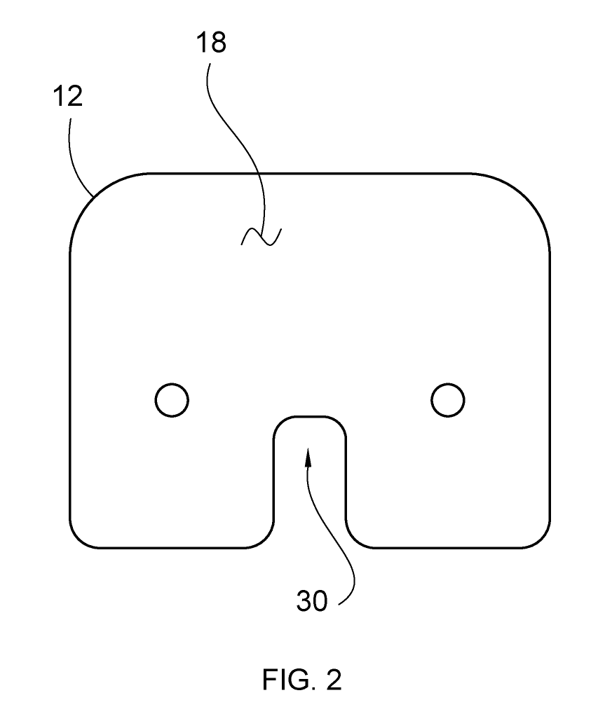

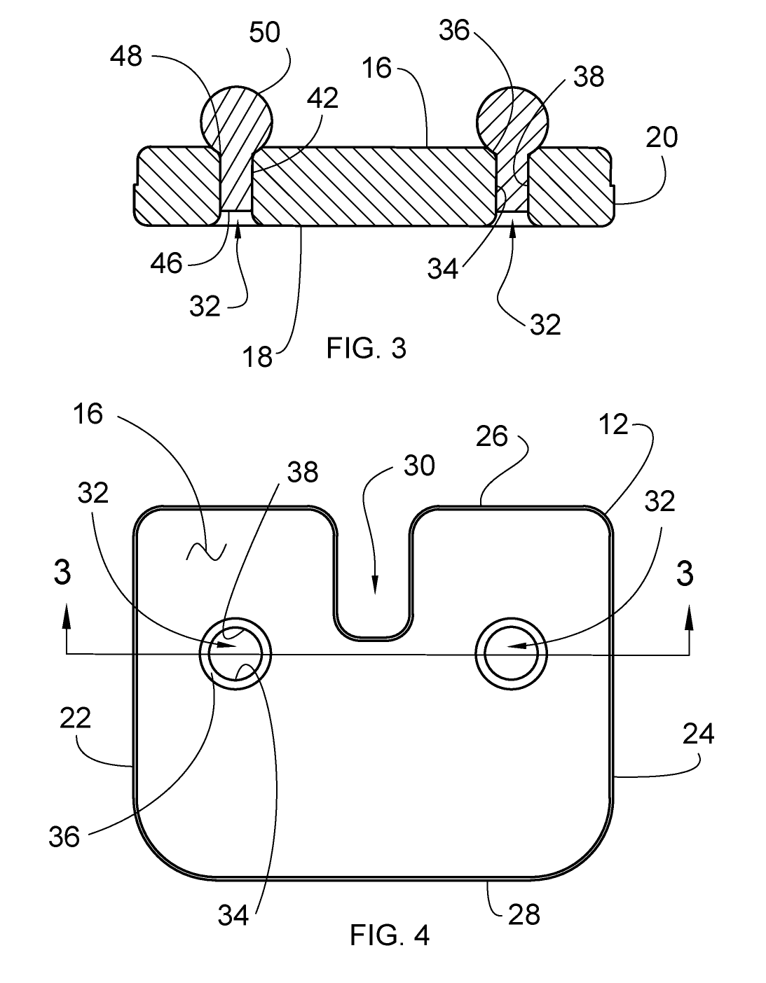

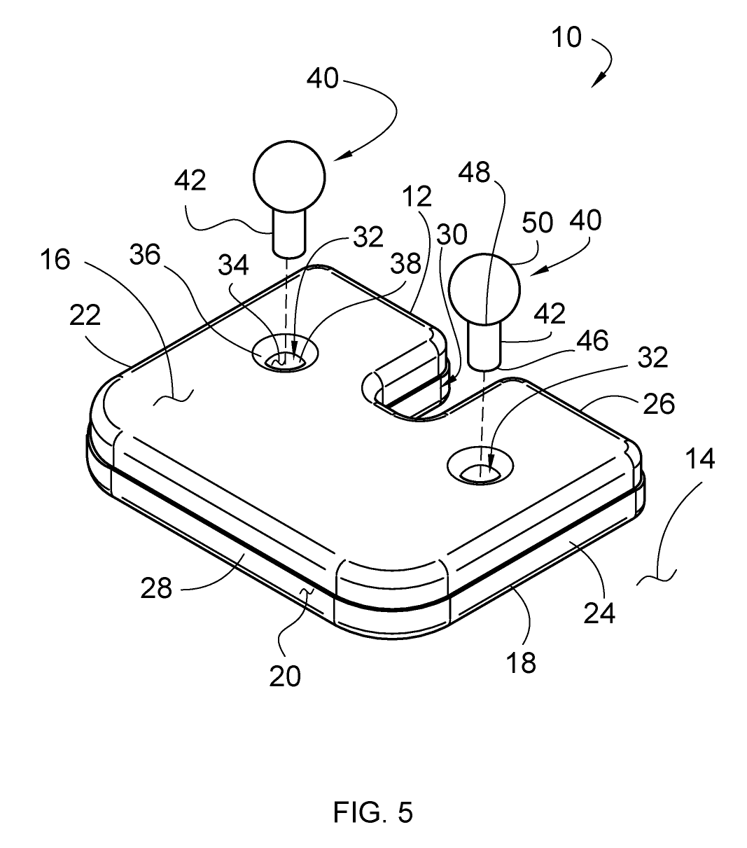

With reference now to the drawings, and in particular to FIGS. 1 through 7 thereof, a new therapy device embodying the principles and concepts of an embodiment of the disclosure and generally designated by the reference numeral 10 will be described.

As best illustrated in FIGS. 1 through 7, the sciatica therapy assembly 10 generally comprises a pad 12 that may be positioned on a support surface 14 thereby facilitating the pad 12 to be sat upon. The support surface 14 may be a seat in a vehicle, a chair, a floor and any other support surface 14 capable of supporting a human being. The pad 12 has a top surface 16, a bottom surface 18 and a peripheral surface 20 extending therebetween. The peripheral surface 20 has a first lateral side 22, a second lateral side 24, a front side 26 and a back side 28. The bottom surface 18 is positioned on the support surface 14 and the top surface 16 is sat upon. Moreover, the pad 12 may be comprised of a resiliently compressible material to enhance comfort when sitting on the pad 12.

The front side 26 has a slot 30 extending towards the back side 28 and the slot 30 is centrally positioned between the first lateral side 22 and the second lateral side 24. The slot 30 accommodates male genitalia when the pad 12 is sat upon to enhance comfort for a male user. The pad 12 has a pair of apertures 32 and each of the apertures 32 extends through the top surface 16 and the bottom surface 18. Each of the apertures 32 is positioned closer to the front side 26 than the back side 28 and each of the apertures 32 is positioned between the slot 30 and an associated one of the first lateral side 22 and the second lateral side 24. Each of the apertures 32 has a bounding surface 34 and the bounding surface 34 corresponding to each of the apertures 32 has a first portion 36 and a second portion 38. The first portion 36 of the bounding surface 34 corresponding to each of the apertures 32 angles outwardly between the second portion 38 of bounding surface 34 of the corresponding aperture and the top surface 16. Thus, each of the apertures 32 has a diameter on the top surface 16 that is greater than a diameter of each of the apertures 32 on the bottom surface 18.

A pair of massagers 40 is provided and each of the massagers 40 is removably positioned in the pad 12. Thus, each of the massagers 40 is sat upon when the pad 12 is sat upon. The massagers 40 are spaced apart from each other on the pad 12 such that each of the massagers 40 is aligned with each of the user's sciatic nerves. In this way the massagers 40 facilitate the sciatic nerves to be massaged for reducing pain and discomfort associated with sciatica.

Each of the massagers 40 comprises a peg 42 that has a first end 46 and a second end 48. The peg 42 is extended into an associated one of the apertures 32 such that the second end 48 is spaced from the top surface 16 of the pad 12. A ball 50 is coupled to the second end 48 of the peg 42. The ball 50 frictionally engages the first portion 36 of the associated aperture when the peg 42 is inserted on to the associated aperture. Thus, the ball 50 is inhibited from passing through the pad 12 thereby facilitating the ball 50 to compress the sciatic nerve when the pad 12 is sat upon.

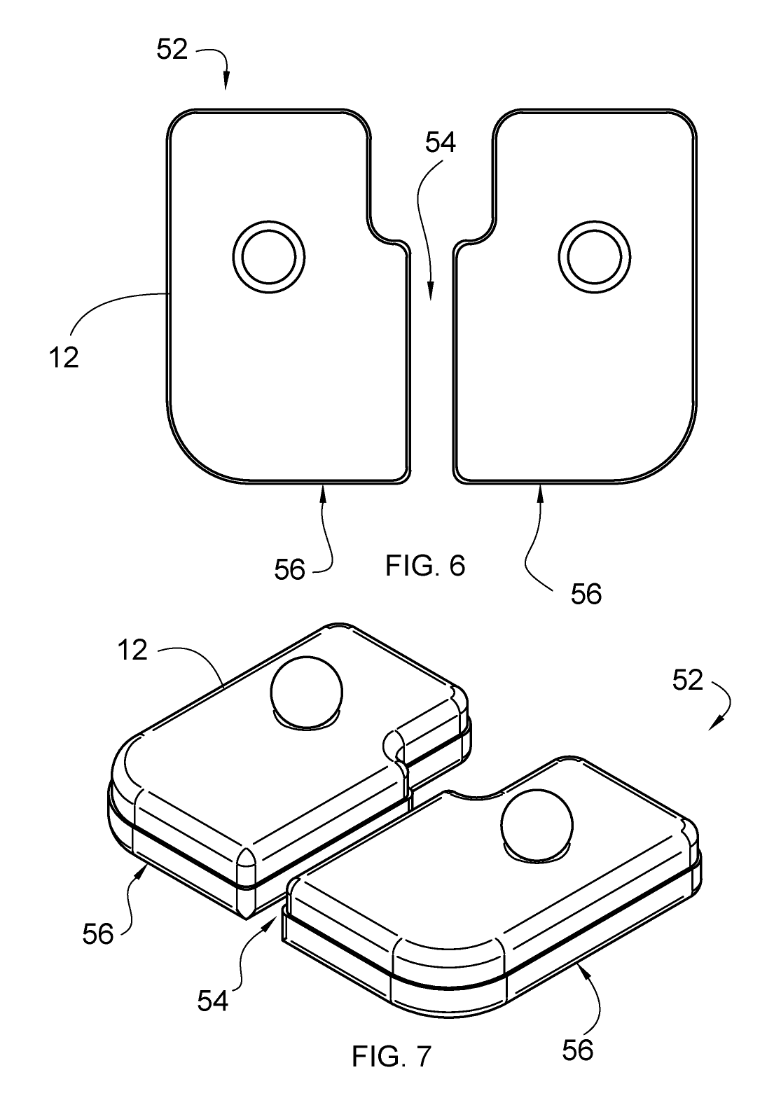

In an alternative embodiment 52 as shown in FIGS. 6 and 7, the pad 12 may have a cut 54 extending through the top surface 16 and the bottom surface 18. The cut 54 may extend through the slot 30 and the back side 28 of the peripheral surface 20 of the pad 12. Thus, the pad 12 may divided into equal halves 56 and each of the equal halves 56 may be selectively positioned on the support surface 14. In this manner the user may massage the sciatic nerve in a selected one of the user's legs rather than both of the user's legs. Additionally, the equal halves 56 of the pad 12 facilitate the pad 12 to be more easily packed in a suitcase or the like for travelling as compared to the undivided pad 12.

In use, the pad 12 is positioned on the support surface 14 and one or both of the peg 42s is inserted into an associated one of the apertures 32. The peg 42 corresponding to both massagers 40 are inserted into the apertures 32 when the user wishes to massage the sciatic nerve in both legs. The peg 42 corresponding to one of massagers 40 is inserted into the associated aperture 32 when the user wishes to massage the sciatic nerve in only one of the legs. The user sits on the pad 12 such that the ball 50 is positioned between the user's hip and the user's thigh thereby facilitating the ball 50 to put pressure on the sciatic nerve. In this way symptoms of sciatica, such as shooting pain and burning sensations, are relieved while the user is sitting.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A sciatica therapy assembly being configured to be sat upon thereby applying pressure to an aggravated sciatic nerve for reducing pain, said assembly comprising:
a pad being configured to be positioned on a support surface thereby facilitating said pad to be sat upon; and
a pair of massagers, each of said massagers being removably positioned in said pad wherein each of said massagers is configured to be sat upon when said pad is sat upon, said massagers being spaced apart from each other on said pad wherein each of said massagers is configured to be aligned with each of the user's sciatic nerves thereby facilitating the sciatic nerves to be massaged for reducing pain and discomfort associated with sciatica.

2. The assembly according to claim 1, wherein said pad has a top surface, a bottom surface and a peripheral surface extending therebetween, said peripheral surface having a first lateral side, a second lateral side, a front side and a back side, said bottom surface being configured to be positioned on the support surface, said top surface being configured to be sat upon, said front side having a slot extending towards said back side, said slot being centrally positioned between said first lateral side and said second lateral side.

3. The assembly according to claim 2, wherein said pad has a pair of apertures, each of said apertures extending through said top surface and said bottom surface, each of said apertures being positioned closer to said front side than said back side, each of said apertures being positioned between said slot and an associated one of said first lateral side and said second lateral side.

4. The assembly according to claim 3, wherein each of said apertures has a bounding surface, said bounding surface having a first portion and a second portion, said first portion of said bounding surface corresponding to each of said apertures angling outwardly between said second portion of said bounding surface of said corresponding aperture and said top surface such that each of said apertures has a diameter on said top surface being greater than a diameter of each of said apertures on said bottom surface.

5. The assembly according to claim 3, wherein each of said massagers comprises a peg having a first end and a second end, said peg being extended into an associated one of said apertures such that said second end is spaced from said top surface of said pad.

6. The assembly according to claim 5, wherein:
each of said apertures has a bounding surface, said bounding surface of each of said apertures having a first portion; and
each of said massagers includes a ball being coupled to said second end of said peg, said ball frictionally engaging said first portion of said bounding surface of said associated aperture such that said ball is inhibited from passing through said pad wherein said ball is configured to compress the sciatic nerve when said pad is sat upon.

7. A sciatica therapy assembly being configured to be sat upon thereby applying pressure to an aggravated sciatic nerve for reducing pain, said assembly comprising:
a pad being configured to be positioned on a support surface thereby facilitating said pad to be sat upon, said pad having a top surface, a bottom surface and a peripheral surface extending therebetween, said peripheral surface having a first lateral side, a second lateral side, a front side and a back side, said bottom surface being configured to be positioned on the support surface, said top surface being configured to be sat upon, said front side having a slot extending towards said back side, said slot being centrally positioned between said first lateral side and said second lateral side, said pad having a pair of apertures, each of said apertures extending through said top surface and said bottom surface, each of said apertures being positioned closer to said front side than said back side, each of said apertures being positioned between said slot and an associated one of said first lateral side and said second lateral side, each of said apertures having a bounding surface, said bounding surface corresponding to each of said apertures having a first portion and a second portion, said first portion corresponding to each of said apertures angling outwardly between said second portion of said corresponding aperture and said top surface such that each of said apertures has a diameter on said top surface being greater than a diameter of each of said apertures on said bottom surface; and
a pair of massagers, each of said massagers being removably positioned in said pad wherein each of said massagers is configured to be sat upon when said pad is sat upon, said massagers being spaced apart from each other on said pad wherein each of said massagers is configured to be aligned with each of the user's sciatic nerves thereby facilitating the sciatic nerves to be massaged for reducing pain and discomfort associated with sciatica, each of said massagers comprising:
a peg having a first end and a second end, said peg being extended into an associated one of said apertures such that said second end is spaced from said top surface of said pad; and
a ball being coupled to said second end of said peg, said ball frictionally engaging said first portion of said associated aperture such that said ball is inhibited from passing through said pad wherein said ball is configured to compress the sciatic nerve when said pad is sat upon.
